(19) United States
(12) Patent Application Publication
(10) Pub. No.: US 2025/0047020 A1
(43) Pub. Date: Feb. 6, 2025

(54) POWER CONNECTOR AND POWER TERMINAL ASSEMBLY

(71) Applicant: OUPIIN ELECTRONIC(KUNSHAN) CO., LTD, Kunshan City (CN)

(72) Inventor: Hsin Chih CHEN, Kunshan City (CN)

(21) Appl. No.: 18/408,833

(22) Filed: Jan. 10, 2024

(30) Foreign Application Priority Data
Aug. 4, 2023 (CN) 202310980347.6
Aug. 4, 2023 (CN) 202322097884.4

(51) Int. Cl. H01R 12/71

(52) U.S. Cl. CPC H01R 12/716

(57) ABSTRACT

A power connector and a power terminal assembly are disclosed in this application. The power connector includes an insulating body and at least one pair of power terminal assemblies. In the pair of power terminal assemblies, each power terminal assembly includes a first power terminal and a second power terminal that form a stacked structure to ensure high current transmission. A first airflow passage is formed between a first fixed plate of the first power terminal and a second fixed plate of the second power terminal. A second airflow passage is formed between a first conductive sheet of the first power terminal and a second conductive sheet of the second power terminal. The second airflow passage is connected to the first airflow passage. The power terminal assembly of the present application can achieve the better balance between high current transmission and low temperature rise.

### FIELD OF ART

The present application relates to a field of connector technology, and more specifically to a power connector and a stacked power terminal assembly.

### BACKGROUND OF DISCLOSURE

As a market demand for a higher current-carrying power connector increases, it is important to ensure power integrity, thermal reliability, operational safety, and electrical performance testing of the high current power connector. Especially, a working current of the high current power connector is greater than that of a conventional power connector, and the temperature rise thereof also increases. Therefore, how to properly handle the generation of the high current in a smaller card edge space and how to achieve a best balance between thermal effects of a power supply and a space design requirement of a PCB, in order to ensure safety performance of a final product, has become an urgent issue to be solved.

A Chinese patent document with publication number CN110391528A discloses an electrical connector, which has an insulating body and a plurality of power terminal pairs secured in the insulating body. In order to effectively improve a heating situation of the power terminal pairs, contacting portions of two power terminals in each power terminal pair are arranged alternately and cyclically. However, because a front end of the power terminal is divided into multiple of the narrow contacting portions, impedance of the power terminal increases. This will not only affect the transmission of the high current, but also generate higher thermal energy at the power terminals, so that exceeding a temperature range that the electrical connector can withstand.

A Chinese patent document with publication number CN203250889U discloses a connector with a copper bar mating structure. In the connector, a spring assembly includes two opposite high conductive parts and two opposite high elastic parts. The two opposite high elastic parts covers outer sides of the two high conductive parts, thereby clamping the high conductive parts. The high conductive part is made of a high conductive material and lacks elasticity. The high elastic part is made of a low conductive material, but has high elasticity. By combining two materials, the spring assembly can achieve good elasticity while maintaining high conductivity. However, in this design, due to the low conductivity of the high elastic part, the high elastic part cannot bear the high current for the high conductive part, so the spring assembly is difficult to achieve high current transmission. Moreover, Because a fixed space between the spring assembly and a plastic base used to fix the spring assembly is limited, the heat of the high conductivity part cannot be timely dissipated into air solely by the highly elastic part contacting the high conductivity part.

Hence, it is necessary to provide a safer and more reliable power connector and a power terminal assembly to achieve a best balance between high current and low temperature rise.

### BRIEF SUMMARY OF DISCLOSURE

One object of the present application is to provide a power connector, which adopts a stacked power terminal assembly to improve a current-carrying capacity and reduce thermal effect.

The other object of the present application is to provide a power terminal assembly being capable of achieving a better balance between high current and low temperature rise.

Other objects and advantages of the present application may be further understood from technical features disclosed by the present application.

To achieve the above objects of the present application, the present application adopts the following technical solution.

A power connector comprises an insulating body and at least one pair of power terminal assemblies being retained in the insulating body for engaging with a docking element to transmit power. The pair of power terminal assemblies comprises two power terminal assemblies. Each power terminal assembly comprises a first power terminal and a second power terminal. The first power terminal has a first fixed plate, at least one first conductive sheet connected to the first fixed plate, and at least one first tail portion connected to the first fixed plate. The first conductive sheet has a first front surface and a first back surface disposed opposite to each other. The first front surface is used to electrically contact the docking element. The second power terminal has a second fixed plate, at least one second conductive sheet connected to the second fixed plate, and at least one second tail portion connected to the second fixed plate. The second conductive sheet has a second front surface and a second back surface disposed opposite to each other. The second front surface faces the first back surface. Wherein, when the docking element is inserted into the power connector, the first front surface of the first conductive sheet electrically contacts the docking element, a head end of the second conductive sheet presses onto the first back surface of the first conductive sheet, and the first conductive sheet and the second conductive sheet form an electrical conduction for commonly transmitting the power. Wherein, a first airflow passage is defined between the first fixed plate and the second fixed plate. Wherein, a second airflow passage is defined between the first conductive sheet and the second conductive sheet. Wherein, the second airflow passage is communicated with the first airflow passage.

In one embodiment, the first power terminal is provided with a plurality of the first conductive sheets arranged in parallel along a straight line; the second power terminal is provided with a plurality of the second conductive sheets arranged in parallel along a straight line; the first conductive sheet and the second conductive sheet have different numbers; the first conductive sheet and the second conductive sheet have different widths.

In one embodiment, when the first front surfaces of the first conductive sheets electrically contact the docking element, the head ends of at least two of the second conductive sheets commonly press onto the first back surface of one of the first conductive sheets; the width of the second conductive sheet is smaller than the width of the first conductive sheet.

In one embodiment, when the first front surfaces of the first conductive sheets electrically contact the docking element, the head ends of three of the second conductive sheets commonly press onto the first back surfaces of two of the first conductive sheets; and the second conductive sheet in an intermediate position of the three of the second conductive sheets rides on the two of the first conductive sheets to press onto the first back surfaces of the two of the first conductive sheets; the width of the second conductive sheet is smaller than the width of the first conductive sheet.

In one embodiment, when the first front surfaces of the first conductive sheets electrically contact the docking element, the head end of one of the second conductive sheets presses onto the first back surfaces of at least two of the first conductive sheets; the width of the second conductive sheet is greater than the width of the first conductive sheet.

In one embodiment, the first airflow passage and the second airflow passage have different widths.

In one embodiment, the first conductive sheet has an inclined section connected to the first fixed plate; the inclined section is bent and tilted toward the second conductive sheet to make the first conductive sheet close to the second conductive sheet; the width of the second airflow passage is smaller than the width of the first airflow passage.

In one embodiment, in the pair of power terminal assemblies, the second power terminals of one power terminal assembly and the other power terminal assembly are located on an inside of the pair of power terminal assemblies; and the second back surfaces of the second power terminals face each other; the first power terminals of one power terminal assembly and the other power terminal assembly are located on an outside of the pair of power terminal assemblies; and the first front surfaces of the first power terminals face away from each other; the first fixed plate and the second fixed plate are both upright, and have same widths and same heights; the first fixed plate and the second fixed plate are parallel to each other.

In one embodiment, in the pair of power terminal assemblies, the first front surface of the first power terminal of one power terminal assembly faces the the first front surface of the first power terminal of the other power terminal assembly for commonly holding the docking element and electrically contacting the docking element; the first fixed plate and the second fixed plate are both L-shaped, and have same widths; the first fixed plate and the second fixed plate form a stacked type.

To achieve the above objects of the present application, the present application also adopts the following technical solution.

A power terminal assembly is used to engage with a docking element to transmit power, the power terminal assembly comprises a first power terminal and a second power terminal. The first power terminal has a first fixed plate, at least one first conductive sheet connected to the first fixed plate, and at least one first tail portion connected to the first fixed plate. The first conductive sheet is capable of electrically contacting the docking element. The second power terminal has a second fixed plate, at least one second conductive sheet connected to the second fixed plate, and at least one second tail portion connected to the second fixed plate. Wherein, when the first conductive sheet electrically contacts the docking element, a head end of the second conductive sheet presses onto the first conductive sheet, and the first conductive sheet and the second conductive sheet are formed to electrical conduction for commonly transmitting the power. Wherein, a first airflow passage is defined between the first fixed plate and the second fixed plate. Wherein, a second airflow passage is defined between the first conductive sheet and the second conductive sheet. Wherein, the second airflow passage is communicated with the first airflow passage, and the first airflow passage and the second airflow passage have different widths. Wherein, the first conductive sheet and the second conductive sheet have different widths.

In comparison with the prior art, the power connector of the present application adopts the stacked power terminal assembly to improve a current-carrying capacity. The first power terminal and the second power terminal can distribute the current more evenly, thereby making the power connector of the present application suitable for high current transmission. Moreover, due to the formation of the first airflow passage between the first fixed plate and the second fixed plate corresponding to each other, and the formation of the second airflow passage between the first conductive sheet and the second conductive sheet corresponding to each other, the second airflow passage is communicated with the first airflow passage, thereby reducing thermal effect and ensuring that the power terminal assembly can achieve optimal balance between high current transmission and low temperature rise.

### BRIEF DESCRIPTION OF DRAWINGS

FIG. 1 is a perspective schematic view of a first embodiment of a power connector of the present application;

FIG. 2 is an exploded schematic view of the power connector of FIG. 1;

FIG. 3 is a structure schematic view of one pair of power terminal assemblies of FIG. 2;

FIG. 4 is a detailed schematic view of one power terminal assembly of FIG. 3;

FIG. 5 is a perspective schematic view of a second embodiment of a power connector of the present application;

FIG. 6 is an exploded schematic view of the power connector of FIG. 5;

FIG. 7 is a structure schematic view of one pair of power terminal assemblies of FIG. 6; and

FIG. 8 is a detailed schematic view of one power terminal assembly of FIG. 7.

### DETAILED DESCRIPTION OF PREFERRED EMBODIMENTS

The following description of every embodiment with reference to the accompanying drawings is used to exemplify a specific embodiment, which may be carried out in the present application. Directional terms mentioned in the present application, such as “top”, “bottom”, “front”, “back”, “left”, “right”, “top”, “bottom” etc., are only used with reference to the orientation of the accompanying drawings. Therefore, the used directional terms are intended to illustrate, but not to limit, the present application.

A power connector of the present application includes an insulating body and at least one pair of power terminal assemblies being retained in the insulating body for engaging with a docking element to transmit power. The docking element may be a docking terminal, such as a flat panel terminal; and may be an electronic card, such as a PCB board card.

The following will introduce different embodiments of the power connector in this application, where similar components in different embodiments use associated similar component labels.

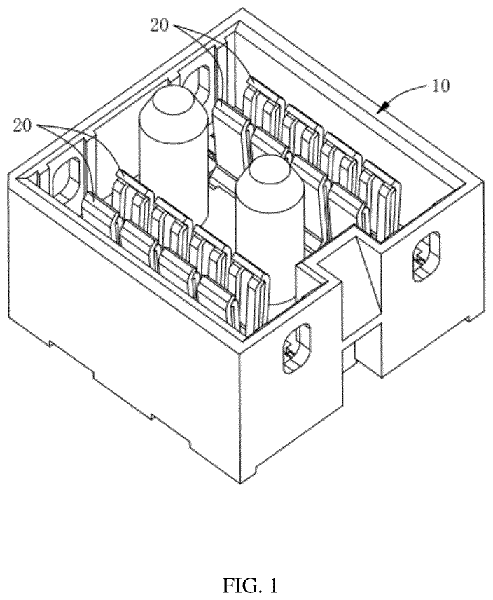

Please refer to FIGS. 1 to 4, a first embodiment of the power connector 1 shown in of the present application is shown.

In the first embodiment, as shown in FIG. 1, the power connector 1 is upright and can be quickly and stably installed on a circuit board (not shown), and an insertion direction of the power connector 1 is perpendicular to the circuit board.

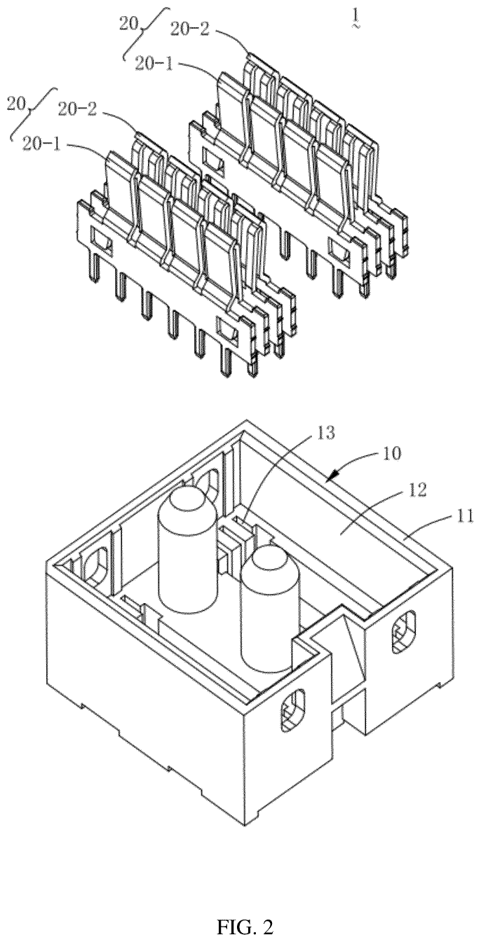

Please refer to FIGS. 1 and 2, the power connector 1 includes an insulating body 10 and two pairs of power terminal assemblies 20 retained in the insulating body 10. The insulating body 10 is upright, and includes a base 11, a mating port 12 disposed on a top of the base 11, and two pairs of terminal channels 13 disposed in the base 11. Each pair of power terminal assemblies 20 includes two power terminal assemblies 20-1 and 20-2, which are retained in the corresponding terminal channels 13 to be ready for engaging with a docking element to transmit power.

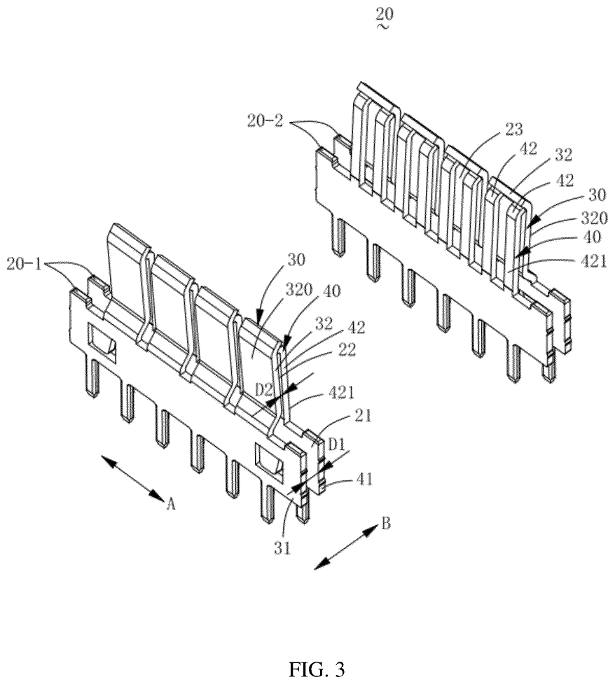

Please refer to FIG. 3, in the pair of power terminal assemblies 20, each power terminal assembly 20-1 (20-2) includes a first power terminal 30 and a second power terminal 40, which form a stacked type.

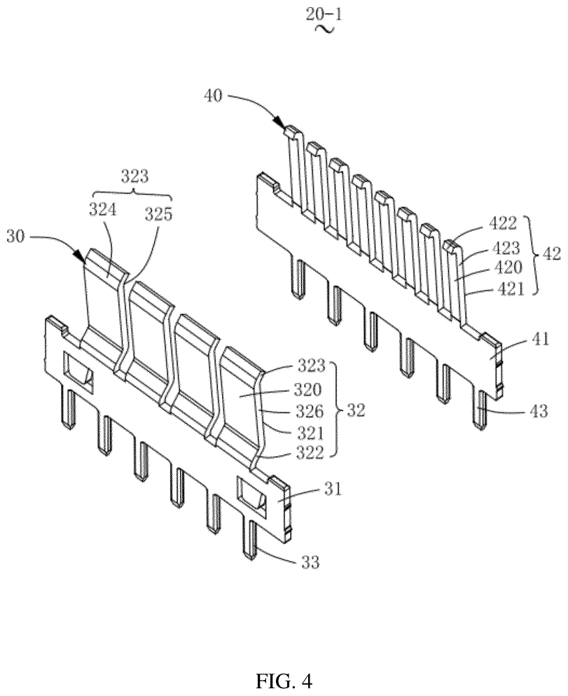

Referring to FIG. 4, the first power terminal 30 has a first fixed plate 31, at least one first conductive sheet 32 connected to the first fixed plate 31, and at least one first tail portion 33 connected to the first fixed plate 31. The first conductive sheet 32 has a first front surface 320 and a first back surface 321 disposed opposite to each other. The first front surface 320 is used to electrically contact the docking element. In the first embodiment, the first fixed plate 31 is upright. The first conductive sheet 32 extends upward from a top edge of the first fixed plate 31, and the first tail portion 33 extends downward from a bottom edge of the first fixed plate 31, so that the whole first power terminal 30 is upright.

Referring to FIG. 4, the second power terminal 40 has a second fixed plate 41, at least one second conductive sheet 42 connected to the second fixed plate 41, and at least one second tail portion 43 connected to the second fixed plate 41. The second conductive sheet 42 has a second front surface 420 and a second back surface 421 disposed opposite to each other. The second front surface 420 faces the first back surface 321, and the second back surface 421 faces away from the first back surface 321. In the first embodiment, the second fixed plate 41 is upright. The second conductive sheet 42 extends upward from a top edge of the second fixed plate 41, and the second tail portion 43 extends downward from a bottom edge of the second fixed plate 41, so that the whole second power terminal 40 is upright.

When the docking element is inserted into the power connector 1, the first front surface 320 of the first conductive sheet 32 electrically contacts the docking element, a head end 422 of the second conductive sheet 42 presses onto the first back surface 321 of the first conductive sheet 32, so that the first conductive sheet 32 and the second conductive sheet 42 can form an electrical conduction to commonly transmit the power. Therefore, the power connector 1 can improve a current-carrying capacity by adopting the stacked power terminal assembly 20-1 (20-2).

Furthermore, in the first embodiment, before the docking element is inserted into the power connector 1, the head end 422 of the second conductive sheet 42 has pressed onto the first back surface 321 of the first conductive sheet 32. After the docking element is inserted into the power connector 1, the head end 422 of the second conductive sheet 42 continues to press onto the first back surface 321 of the first conductive sheet 32 for commonly transmitting the power.

But, in another embodiment, before the docking element is inserted into the power connector 1, the head end 422 of the second conductive sheet 42 does not press onto the first back surface 321 of the first conductive sheet 32. Namely, the both do not contact each other or do not form connection. And after the docking element is inserted into the power connector 1, the docking element can force the first conductive sheet 32 to be slightly elastically offset toward the second conductive sheet 42, so that the head end 422 of the second conductive sheet 42 can press onto the first back surface 321 of the first conductive sheet 32 for commonly transmitting the power.

As can be seen, the present application does not limit whether or not the second conductive sheet 42 and the first conductive sheet 32 form contact or connection before the docking element is inserted into the power connector 1. It is only necessary that the second conductive sheet 42 and the first conductive sheet 32 are able to form contact or connection after the docking element is inserted into the power connector 1.

Referring to FIG. 3, a first airflow passage 21 is defined between the first fixed plate 31 and the second fixed plate 41. A second airflow passage 22 is defined between the first conductive sheet 32 and the second conductive sheet 42. The second airflow passage 22 is communicated with the first airflow passage 21. Therefore, the power connector 1 can reduce thermal effect by adopting the stacked power terminal assembly 20-1 (20-2), and the power terminal assembly 20-1 (20-2) is capable of achieving a best balance between high current and low temperature rise.

In the present application, the first power terminal 30 is provided with a plurality of the first conductive sheets 32 arranged in parallel along a straight line. For example, in the first embodiment, the first power terminal 30 is provided with four first conductive sheets 32 arranged side by side from left to right.

In the present application, the second power terminal 40 is provided with a plurality of the second conductive sheets 42 arranged in parallel along a straight line. For example, in the first embodiment, the second power terminal 40 is provided with eight second conductive sheets 42 arranged side by side from left to right.

In the first embodiment, each two of the second conductive sheets 42 are corresponding to one of the first conductive sheets 32. Specifically, when the first front surfaces 320 of the first conductive sheets 32 electrically contact the docking element, the head ends 422 of two second conductive sheets can commonly press onto the first back surface 321 of one first conductive sheet 32. According to the first embodiment, it can be conceivable that, in other embodiment, the power terminal assembly 20-1 (20-2) may be provided such that each three or more of the second conductive sheets 42 correspond to one of the first conductive sheets 32.

In general, the first conductive sheet 32 and the second conductive sheet 42 may have different numbers and different widths. The widths here refer to a distance along a left-right direction A in FIG. 3. Specifically, the number of the second conductive sheet 42 is greater than the number of the first conductive sheet 32, and the width of the second conductive sheet 42 is smaller than the width of the first conductive sheet 32. Even so, the width of the second conductive sheet 42 is smaller than half of the width of the first conductive sheet 32. By this design, a third airflow passage 23 (label can be seen in FIG. 3) is formed between the second conductive sheets 42, thereby further reducing thermal effect. Moreover, this uniform configuration of the multiple second conductive sheets 42 can serve to evenly share the high current.

Please refer to FIG. 3, the first airflow passage 21 and the second airflow passage 22 have different widths.

Specifically, referring to FIG. 4, the first conductive sheet 32 has an inclined section 322 connected to the first fixed plate 31. The inclined section 322 is bent and tilted toward the second conductive sheet 42 to make the first conductive sheet 32 close to the second conductive sheet 42. Therefore, the width D2 of the second airflow passage 22 is smaller than the width D1 of the first airflow passage 21. The widths D1 and D2 refer to a distance along a front-rear direction B in FIG. 3.

Please refer to FIG. 4, the first conductive sheet 32 has a head section 323. The head section 323 is bent toward the second conductive sheet 42 and forms a curved shape. The head section 323 has an outer curved segment 324 disposed on the first front surface 320 and an inner curved segment 325 disposed on the first back surface 321. The head end 422 of the second conductive sheet 42 is bent toward the first conductive sheet 32 so as to be in the form of a curved hook. When the power connector 1 is engaged with the docking element, the head end 422 of the second conductive sheet 42 presses onto the inner curved segment 325 of the first conductive sheet 32, so that the first conductive sheet 32 and the second conductive sheet 42 form an electrical conduction for commonly transmitting the power.

Please refer to FIG. 4, the first conductive sheet 32 further has a first straight section 326. The first straight section 326 is located between the head section 323 and the inclined section 322. The first conductive sheet 32 forms the electrical connection with the docking element at the first straight section 326. The second conductive sheet 42 has a second straight section 423. The second straight section 423 corresponds to and is substantially parallel to the first straight section 326.

Please refer to FIG. 3, in the pair of power terminal assemblies 20, the second power terminals 40 of one power terminal assembly 20-1 and the other power terminal assembly 20-2 are located on an inside of the pair of power terminal assemblies 20; and the second back surfaces 421 of the second power terminals 40 face each other. The first power terminals 30 of one power terminal assembly 20-1 and the other power terminal assembly 20-2 are located on an outside of the pair of power terminal assemblies 20; and the first front surfaces 320 of the first power terminals 30 face away from each other. In other words, the pair of power terminal assemblies 20 are configured that the first power terminal 30, the second power terminal 40, the second power terminal 40 and the first power terminal 30 are arranged in sequence.

Moreover, as shown in FIG. 4, the first fixed plate 31 and the second fixed plate 41 have the same width along the left-right direction and the same height along an up-down direction, and are both of an upright type. The first fixed plate 31 and the second fixed plate 41 are parallel to each other. The first power terminal 30 is further provided with a plurality of the first tail portions 33 arranged in parallel along a straight line. The second power terminal 40 is further provided with a plurality of the second tail portions 43 arranged in parallel along a straight line. The first tail portions 33 are parallel to the second tail portions 43.

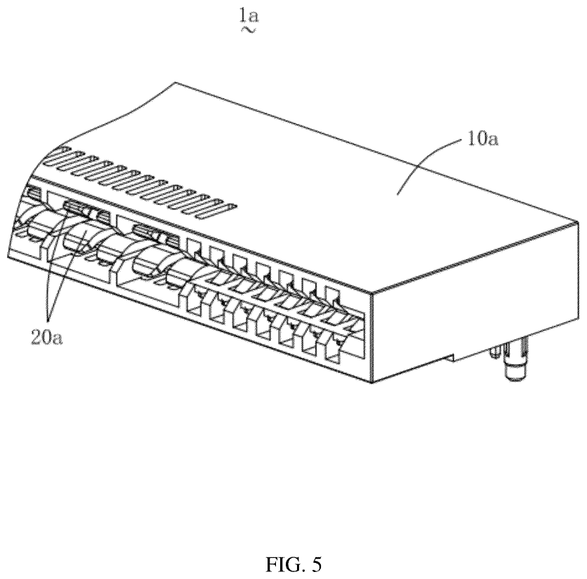

The following will introduce a second embodiment of the power connector 1 of the present application in conjunction with FIGS. 5 to 8.

In the second embodiment, referring to FIG. 5, the power connector 1 may also be a right-angled power connector 1a, which can be installed on the circuit board and which is plugged in a direction parallel to the circuit board.

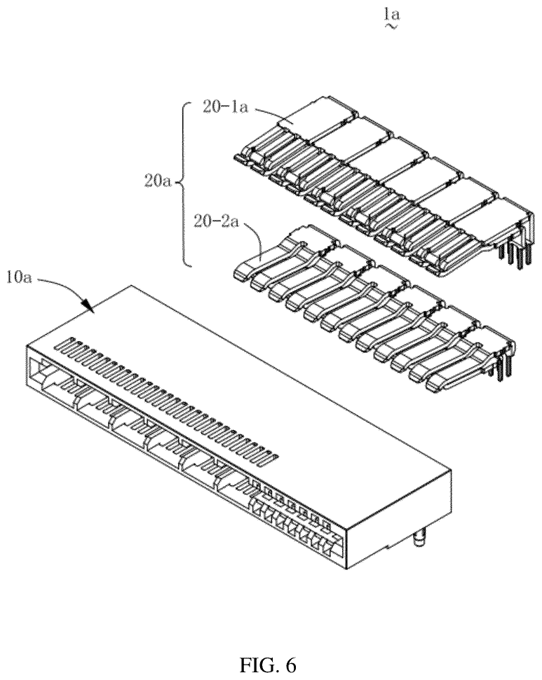

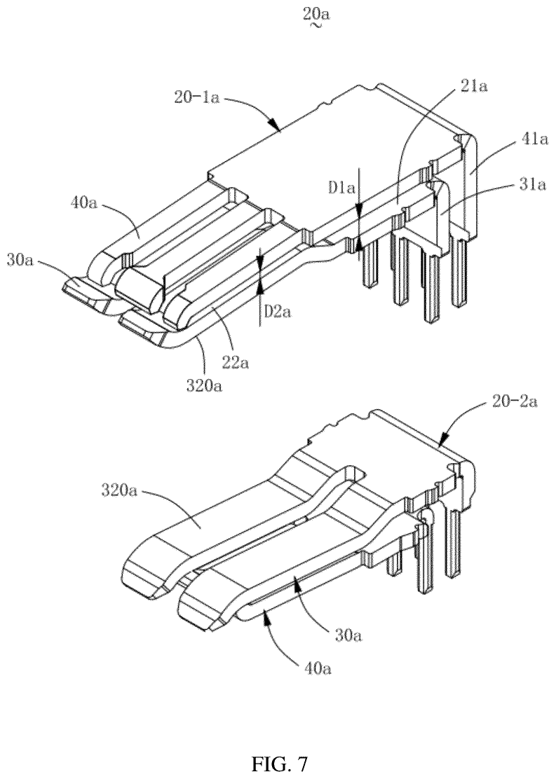

Please refer to FIGS. 5 and 6, the power connector 1a includes an insulating body 10a and six pairs of power terminal assemblies 20a retained in the insulating body 10a. The insulating body 10a is right-angled. Each pair of power terminal assemblies 20a includes two power terminal assemblies 20-1a and 20-2a, which are ready for engaging with the docking element to transmit power. Further, in the second embodiment, the power connector 1a further includes an additional base (not shown) for further retaining the power terminal assemblies 20-1a and 20-2a, and a plurality of signal terminals (not shown) retained in the insulating body 10a and the additional base. Please refer to FIG. 7, in the pair of power terminal assemblies 20a, each power terminal assembly 20-1a (20-2a) includes a first power terminal 30a and a second power terminal 40a, which form a stacked type.

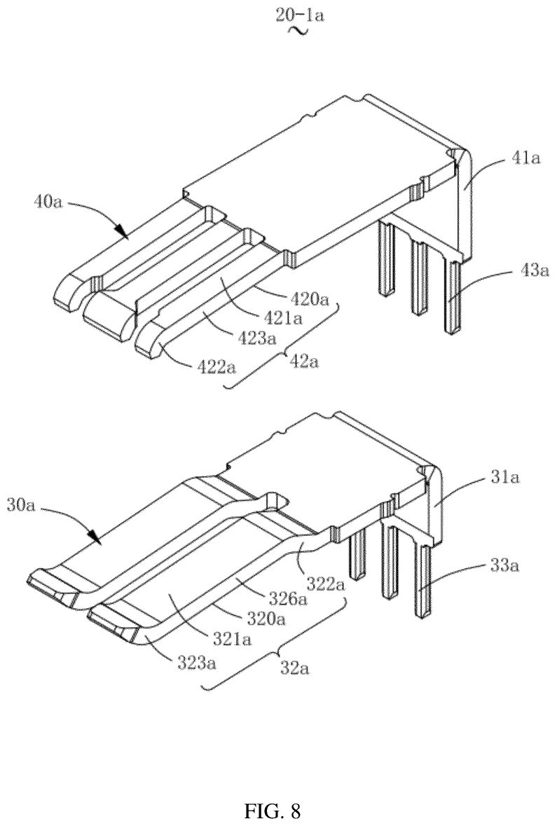

Referring to FIG. 8, the first power terminal 30a is L-shaped, and has an L-shaped first fixed plate 31a, at least one first conductive sheet 32a being connected to the first fixed plate 31a and extending horizontally, and at least one first tail portion 33a being connected to the first fixed plate 31a and extending vertically. The first conductive sheet 32a has a first front surface 320a and a first back surface 321a disposed opposite to each other. The first front surface 320a is used to electrically contact the docking element.

Referring to FIG. 8, the second power terminal 40a is L-shaped, and has an L-shaped second fixed plate 41a, at least one second conductive sheet 42a being connected to the second fixed plate 41a and extending horizontally, and at least one second tail portion 43a being connected to the second fixed plate 41a and extending vertically. The second conductive sheet 42a has a second front surface 420a and a second back surface 421a disposed opposite to each other. The second front surface 420a face the first back surface 321a.

When the first front surface 320a of the first conductive sheet 32a is in electrical contact with the docking element, the head end 422a of the second conductive sheet 42a presses onto the first back surface 321a of the first conductive sheet 32a, so that the first conductive sheet 32a and the second conductive sheet 42a form an electrical conduction for commonly transmitting the power. Therefore, the power connector 1a can improve a current-carrying capacity by adopting the stacked power terminal assembly 20-1a (20-2a).

It is to be noted herein that the present application does not limit whether or not the second conductive sheet 42a and the first conductive sheet 32a form contact or connection before the docking element is inserted into the power connector 1a. It is only necessary that the second conductive sheet 42a and the first conductive sheet 32a are able to form contact or connection after the docking element is inserted into the power connector 1a.

Referring to FIG. 7, a first airflow passage 21a is defined between the first fixed plate 31a and the second fixed plate 41a, a second airflow passage 22a is defined between the first conductive sheet 32a and the second conductive sheet 42a, and the second airflow passage 22a is communicated with the first airflow passage 21a. Therefore, the power connector 1a can reduce thermal effect by adopting the stacked power terminal assembly 20-1a (20-2a), and the power terminal assembly 20-1a (20-2a) is capable of achieving a best balance between high current and low temperature rise.

In the second embodiment, as shown in FIG. 8, the first power terminal 30a of the present application is provided with two first conductive sheets 32a arranged in parallel along a straight line. The second power terminal 40a of the present application is provided with three second conductive sheets 42a arranged in parallel along a straight line. The three second conductive sheets 42a are corresponding to the two first conductive sheets 32a. Namely, when the first front surfaces 320a of the first conductive sheets 32a electrically contact the docking element, the head ends 422a of the three second conductive sheets 42a can press onto the first back surfaces 321a of the two first conductive sheets 32a, and the second conductive sheet 42a in an intermediate position rides on the two first conductive sheets 32a to press onto the first back surfaces 321a of the two first conductive sheets 32a. By this design, the first power terminal 30a and the second power terminal 40a can distribute the current more evenly, thereby making the power connector 1a suitable for high current transmission.

Of course, in other embodiment, the power terminal assembly 20-1a (20-2a) can also be configured that: each two first conductive sheets 32a correspond to one second conductive sheet 42a. When the first front surfaces 320a of the first conductive sheets 32a electrically contact the docking element, the head end 422a of the one second conductive sheets 42a can press onto the first back surfaces 321a of the two first conductive sheets 32a. Now, the width of the second conductive sheet 42a is greater than the width of the first conductive sheet 32a.

In the second embodiment, the first conductive sheet 32a has an inclined section 322a, which is bent and tilted toward the second conductive sheet 42a to make the first conductive sheet 32a close to the second conductive sheet 42a. Therefore, the width D2a of the second airflow passage 22a is smaller than the width Dla of the first airflow passage 21a. As can be seen, the first conductive sheet 32a and the second conductive sheet 42a not only define the second airflow passage 22a therebetween, but also build a flat structure to reduce a card edge space at a front of the connector.

Moreover, referring to FIG. 8, the first conductive sheet 32a has a curved head section 323a, the head end 422a of the second conductive sheet 42a is also curved. When the first conductive sheet 32a electrically contacts the docking element, the head end 422a of the second conductive sheet 42a presses onto the head section 323a of the first conductive sheet 32a, so that the first conductive sheet 32a and the second conductive sheet 42a form an electrical conduction for commonly transmitting the power.

Please refer to FIG. 8, the first conductive sheet 32a further has a first straight section 326a. The second conductive sheet 42a has a second straight section 423a. The first straight section 326a and the second straight section 423a are corresponding and substantially parallel to each other.

Please refer to FIG. 7, in the pair of power terminal assemblies 20a, the first front surface 320a of the first power terminal 30a of one power terminal assembly 20-1a faces the first front surface 320a of the first power terminal 30a of the other power terminal assembly 20-2a, thereby commonly holding the docking element and forming an electrical contact with the docking element. More specifically, the pair of power terminal assemblies 20a are configured that the second power terminal 40a, the first power terminal 30a, the first power terminal 30a and the second power terminal 40a are arranged in sequence.

In summary, the power connector 1 (1a) of the present application adopts the stacked power terminal assembly to improve a current-carrying capacity. The first power terminal and the second power terminal can distribute the current more evenly, thereby making the power connector of the present application suitable for high current transmission. Moreover, due to the formation of the first airflow passage between the first fixed plate and the second fixed plate corresponding to each other, and the formation of the second airflow passage between the first conductive sheet and the second conductive sheet corresponding to each other, the second airflow passage is communicated with the first airflow passage, thereby reducing thermal effect and ensuring that the power terminal assembly can achieve optimal balance between high current transmission and low temperature rise.

It should be understood that, the application of the present application is not limited to the above examples listed. Ordinary technical personnel in this field can improve or change the applications according to the above descriptions, all of these improvements and transforms should belong to the scope of protection in the appended claims of the present application.

What is claimed is:

1. A power connector, comprising: an insulating body and at least one pair of power terminal assemblies being retained in the insulating body for engaging with a docking element to transmit power; the pair of power terminal assemblies comprising two power terminal assemblies; each power terminal assembly comprising:
a first power terminal having a first fixed plate, at least one first conductive sheet connected to the first fixed plate, and at least one first tail portion connected to the first fixed plate; the first conductive sheet having a first front surface and a first back surface disposed opposite to each other; the first front surface being used to electrically contact the docking element;
a second power terminal having a second fixed plate, at least one second conductive sheet connected to the second fixed plate, and at least one second tail portion connected to the second fixed plate; the second conductive sheet having a second front surface and a second back surface disposed opposite to each other; the second front surface facing the first back surface;
wherein, when the docking element is inserted into the power connector, the first front surface of the first conductive sheet electrically contacting the docking element, a head end of the second conductive sheet pressing onto the first back surface of the first conductive sheet, and the first conductive sheet and the second conductive sheet forming an electrical conduction for commonly transmitting the power;
wherein, a first airflow passage is defined between the first fixed plate and the second fixed plate;
wherein, a second airflow passage is defined between the first conductive sheet and the second conductive sheet;
wherein, the second airflow passage is communicated with the first airflow passage.

2. The power connector according to claim 1, wherein,
the first power terminal is provided with a plurality of the first conductive sheets arranged in parallel along a straight line;
the second power terminal is provided with a plurality of the second conductive sheets arranged in parallel along a straight line;
the first conductive sheet and the second conductive sheet have different numbers;
the first conductive sheet and the second conductive sheet have different widths.

3. The power connector according to claim 2, wherein,
when the first front surfaces of the first conductive sheets electrically contact the docking element, the head ends of at least two of the second conductive sheets commonly press onto the first back surface of one of the first conductive sheets;
the width of the second conductive sheet is smaller than the width of the first conductive sheet.

4. The power connector according to claim 2, wherein,
when the first front surfaces of the first conductive sheets electrically contact the docking element, the head ends of three of the second conductive sheets commonly press onto the first back surfaces of two of the first conductive sheets; and the second conductive sheet in an intermediate position of the three of the second conductive sheets rides on the two of the first conductive sheets to press onto the first back surfaces of the two of the first conductive sheets;
the width of the second conductive sheet is smaller than the width of the first conductive sheet.

5. The power connector according to claim 2, wherein,
when the first front surfaces of the first conductive sheets electrically contact the docking element, the head end of one of the second conductive sheets presses onto the first back surfaces of at least two of the first conductive sheets;
the width of the second conductive sheet is greater than the width of the first conductive sheet.

6. The power connector according to claim 1, wherein the first airflow passage and the second airflow passage have different widths.

7. The power connector according to claim 6, wherein,
the first conductive sheet has an inclined section connected to the first fixed plate;
the inclined section is bent and tilted toward the second conductive sheet to make the first conductive sheet close to the second conductive sheet;
the width of the second airflow passage is smaller than the width of the first airflow passage.

8. The power connector according to claim 1, wherein,
in the pair of power terminal assemblies,
the second power terminals of one power terminal assembly and the other power terminal assembly are located on an inside of the pair of power terminal assemblies;
and the second back surfaces of the second power terminals face each other;
the first power terminals of one power terminal assembly and the other power terminal assembly are located on an outside of the pair of power terminal assemblies;
and the first front surfaces of the first power terminals face away from each other;
the first fixed plate and the second fixed plate are both upright, and have same widths and same heights;
the first fixed plate and the second fixed plate are parallel to each other.

9. The power connector according to claim 1, wherein,
in the pair of power terminal assemblies, the first front surface of the first power terminal of one power terminal assembly faces the first front surface of the first power terminal of the other power terminal assembly for commonly holding the docking element and electrically contacting the docking element;
the first fixed plate and the second fixed plate are both L-shaped, and have same widths;
the first fixed plate and the second fixed plate form a stacked type.

10. A power terminal assembly for engaging with a docking element to transmit power, the power terminal assembly comprising:
a first power terminal having a first fixed plate, at least one first conductive sheet connected to the first fixed plate, and at least one first tail portion connected to the first fixed plate; the first conductive sheet being capable of electrically contacting the docking element;
a second power terminal having a second fixed plate, at least one second conductive sheet connected to the second fixed plate, and at least one second tail portion connected to the second fixed plate;
wherein, when the first conductive sheet electrically contacts the docking element, a head end of the second conductive sheet presses onto the first conductive sheet, and the first conductive sheet and the second conductive sheet are formed to electrical conduction for commonly transmitting the power;
wherein, a first airflow passage is defined between the first fixed plate and the second fixed plate;
wherein, a second airflow passage is defined between the first conductive sheet and the second conductive sheet;
wherein, the second airflow passage is communicated with the first airflow passage, and the first airflow passage and the second airflow passage have different widths;
wherein, the first conductive sheet and the second conductive sheet have different widths.
